(19) United States
(12) Patent Application Publication
(10) Pub. No.: US 2002/0128939 A1
(43) Pub. Date: Sep. 12, 2002

(54) Method and system for sharing investor information over an electronic network

(76) Inventor: Jeffrey G. Tarrant, New York, NY (US)

Correspondence Address: PENNIE AND EDMONDS, 1155 AVENUE OF THE AMERICAS, NEW YORK, NY, 100362711

(21) Appl. No.: 10/029,731

(22) Filed: Dec. 21, 2001

Related U.S. Application Data
(60) Provisional application No. 60/257,683, filed on Dec. 22, 2000.

(51) Int. Cl. G06F 17/60

(52) U.S. Cl. 705/35

(57) ABSTRACT

The invention comprises a method and system for sharing information over a computer network, the method comprising the steps of: receiving data regarding a particular investment over a computer network from a first user computer; storing the data from the first user in a relational database and identifying the data as coming from the first user, wherein the first user is identified as a member of a hierarchy of sources organized by level of trustworthiness; receiving a request over the computer network from a second user for data from the relational database regarding the particular investment; and, in response to the request from the second user, transmitting the data from the relational database to a second user computer, wherein, absent a request from the second user for data from a specific source or level of trustworthiness, the data transmitted comprise data from users of the highest level of trustworthiness available.

### CROSS-REFERENCE TO RELATED APPLICATIONS

This application claims priority to U.S. Provisional Application No. 60/257,683, filed Dec. 22, 2000, the entire contents of which are incorporated herein by reference.

### BACKGROUND

Information held by private and institutional investors historically has not been shared on a large scale. Types of information investors would want to share, but have historically been unable to share, include information on private investments, LBO (leveraged buyout) funds, venture funds, and hedge funds. In other words, the types of information not readily available in modem databases because no industry-wide participant file-sharing system has thus far been available.

Investment funds generally have multiple investors. Those investors have accurate information about each fund's offering, as well as the fund's performance, that they may want to share with other investors in order to gain access to information on investments not within their own portfolio.

Investors also may want to see aggregate information from investment funds or private investments, to be able to create benchmarks or performance indices. Such information would include types of funds, structures of funds, terms of the deals of the funds, and information on whether certain types of funds appeal to certain types of investors at different periods of time. Knowledge as to whether certain types of funds appeal to certain investors allows investors to share buying power in order to create better investment products for themselves, such as documentation standardization, fee reduction, or offering improvements.

Fund investors, particularly those in hedge funds and private equity, would also like to have a service, preferably Internet-based, that provides the ability to perform transactions along with providing fund information.

### SUMMARY

A preferred embodiment of the present invention comprises a central registry stored on a central database connected to a central server. The central registry contains registration information of participating members and money managers.

A standardized questionnaire is preferably filled out by users of the system. The questionnaire collects investor information regarding alternative investments and their managers. The term “alternative investments” is known in the art and is used herein to refer generally to investments such as hedge funds, private equity (including but not limited to LBOs, venture capital funds, real estate funds, mezzanine funds) and structured products such as collateralized bond obligations (CBOs), collateralized loan obligations (CLOs), and collateralized debt obligations (CDOs).

The system preferably organizes collected data by four hierarchical levels of accuracy or trustworthiness. The highest level (Level A) comprises data submitted by an investment manager, administrator, or sponsor of the fund. The next level (Level B) comprises data submitted by an investor of the fund. This level in turn may have different levels of hierarchy based on a rating system; for example, data from investors who have a history of submitting information that has proven to be reliable will be ranked higher than data from investors who have a history of submitting less reliable information.

The third level (Level C) comprises data entered by operators of the system itself, i.e., an employee of the system operator enters data collected by the system through means other than directly from users—typically, from outside sources or from analysis performed on user-submitted and outside data.

The lowest level (Level D) of data comes in from a third party—typically, another database or a purchased data source.

To ensure that the integrity of the data is relatively high, a preferred hierarchical selection process has the highest order of data quality override the lower orders. For example, when an investment manager inputs their fund data, this would be the highest level of data quality (Level A). In the case of Level B—an investor inputting data on an investment fund or Money Manager—there is preferably a second order of hierarchical evaluation. There are trusted investors whose data is determined to be prompt and more accurate than other investor data sources. Thus, there is a rating system that rates the quality of information that other investors have input to the system.

A preferred method of rating is based upon demand. Investors whose data has been used (or requested) extensively by other users are rated higher than other investors. Such ratings are preferably dynamic—each user's performance, usage, or demand is periodically re-evaluated. A data provider can be rated on accuracy, promptness, completeness of the questionnaire, and activity (e.g., how frequently they participate and contribute data).

In order to join a preferred system, users may remain anonymous but must answer an appropriate questionnaire and state in which level (A-D) they belong.

Preferably, for an information provider in Level D the system uses a handshake protocol between the provider's database and a system database, and licenses the protocol to other users of the system, thus creating a subsystem. In order to qualify to become a member of this subsystem, potential members preferably complete and sign a confidentiality questionnaire and an investor subscription questionnaire that qualify the investor as a significant investor (for example, as a Section 3(c)(1) investor or a Section 3(c)(7) investor under the Securities Acts).

In one embodiment, the system is not only a data-sharing system but also a transaction-based system. The system is preferably registered as a broker dealer, to enable transactions to take place via the system. Users of the system, to maintain a membership at a reduced cost, are required to transact a certain number of trades or purchases of a hedge fund, LBO fund, or venture fund.

Preferably, the system is comprised primarily of sophisticated investors, is password protected, and investors cannot invest in a fund for a period of 30 days (in compliance with two SEC No-Action Letters to Lamp Technologies Inc. (available on Westlaw at 1997 WL 282988 and 1998 WL 278984) relating to private fund data distribution over the Internet). A request for data by a member of the system can either be an individual request or a packaged request (requesting packages (e.g., all funds managed by Manager X) of information over the system).

A preferred embodiment of the system is flexible enough to allow users to share their data (or selected portions of their data) on a global basis (with the entire system) or more specifically with targeted recipients (a “web-of-trust”) for a specified length of time.

Generally, the present invention comprises a method for sharing information over a computer network, comprising the steps of: (a) receiving data regarding a particular investment over a computer network from a first user computer; (b) storing the data from the first user in a relational database and identifying the data as coming from the first user, wherein the first user is identified as a member of a hierarchy of sources organized by level of trustworthiness; (c) receiving a request over the computer network from a second user for data from the relational database regarding the particular investment; and (d) in response to the request from the second user, transmitting the data from the relational database to a second user computer, wherein, absent a request from the second user for data from a specific source or level of trustworthiness, the data transmitted comprise data from users of the highest level of trustworthiness available. In particular embodiments, data received from the first user comprise alternative investment data; sources of the highest level of trustworthiness comprise investment managers, fund administrators, or fund sponsors; sources of at least one level of trustworthiness comprise investors, and the investor level is subdivided into two or more sublevels that are determined at least partly by reliability of previously submitted information; sources of at least one level of trustworthiness comprise investors, and the investor level is subdivided into two or more sublevels, and an investor's sublevel is determined at least partly by amount of demand for the investor's information by other investors; and alternative investment data from the first user comprise fund data.

A further embodiment comprises a method as above, wherein unrecognized funds are identified using at least the following steps: (a) attempting to match an unrecognized fund with existing fund records; (b) if no match is found, searching existing fund records using a sounds-like function; (c) if no match is found by step (b), identifying the unrecognized fund as a new fund; and (d) if multiple matches are found by step (b), transmitting a list of the matches to the first user, with a request to identify the correct fund.

In another aspect, the invention comprises a system for sharing information over a computer network, comprising: (a) means for receiving data regarding a particular investment over a computer network from a first user computer; (b) means for storing the data from the first user in a relational database and identifying the data as coming from the first user, wherein the first user is identified as a member of a hierarchy of sources organized by level of trustworthiness; (c) means for receiving a request over the computer network from a second user for data from the relational database regarding the particular investment; and (d) means for, in response to the request from the second user, transmitting the data from the relational database to a second user computer, wherein, absent a request from the second user for data from a specific source or level of trustworthiness, the data transmitted comprise data from users of the highest level of trustworthiness available.

In another aspect, the invention comprises a system for sharing information over a computer network, comprising: (a) a central database; and (b) a central server linked to the central database and linked to a computer network; wherein the central database is a relational database configured to identify at least some data with the source of the data; and wherein each data source is designated as a member of a hierarchy of sources organized by level of trustworthiness. Further embodiments comprise systems as above, wherein data in the central database comprise alternative investment data; wherein sources of the highest level of trustworthiness comprise investment managers, fund administrators, or fund sponsors; wherein sources of at least one level of trustworthiness comprise investors, and wherein the investor level is subdivided into two or more sublevels that are determined at least partly by reliability of previously submitted information; wherein sources of at least one level of trustworthiness comprise investors, and the investor level is subdivided into two or more sublevels, and an investor's sublevel is determined at least partly by amount of demand for the investor's information by other investors.

In a further aspect, the invention comprises a method of obtaining and providing information regarding alternative investments, comprising the following steps: (a) providing over a computer network in a secure manner to a central server data regarding one or more alternative investments, wherein the alternative investment data comprise financial data and information indicating at least one source of the financial data; (b) requesting information regarding one or more alternative investments; and (c) receiving information comprising the requested information; wherein the central server is in communication with a central database that is a relational database configured to identify at least some data with the source of the data; and wherein each data source is designated as a member of a hierarchy of sources organized by level of trustworthiness.

### BRIEF DESCRIPTION OF THE DRAWINGS

FIG. 1 depicts components of a system according to a preferred embodiment of the present invention.

FIG. 2 illustrates steps carried out in a preferred embodiment.

FIGS. 3-6 further illustrate steps shown in FIG. 2.

### DETAILED DESCRIPTION OF PREFERRED EMBODIMENTS

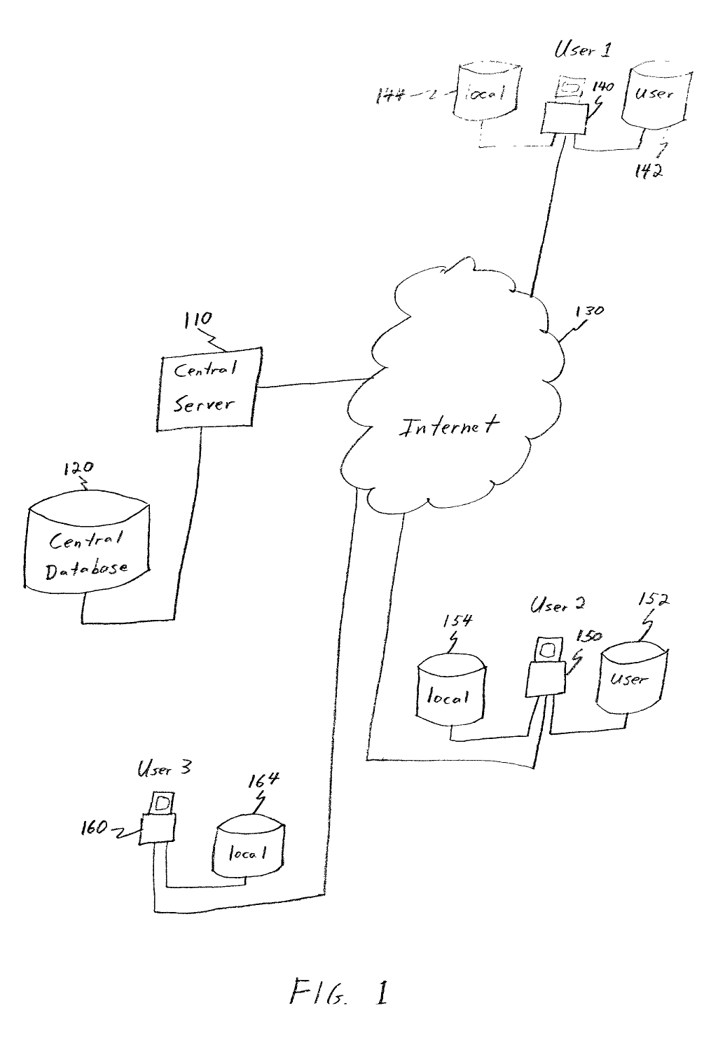

FIG. 1 depicts components of a system according to a preferred embodiment of the present invention. A plurality of users are connected via their computers 140, 150, and 160 to a computer network 130—preferably the Internet. Also connected to computer network 130 is a central server 110.

Each user computer (140, 150, or 160) is connected to a local database (144, 154, and 164, respectively) that stores fund- and manager-related data in the same format as a central database 120 that is connected to central server 110. Preferably, some user computers (140 and 150) are also connected to databases (142 and 152, respectively) that store data in a format specific (but not necessarily unique) to the user. Such users can preferably select, using locally-resident software of a preferred embodiment, what subset of data stored on their own databases 142 and 152 is mapped into databases 144 and 154, respectively.

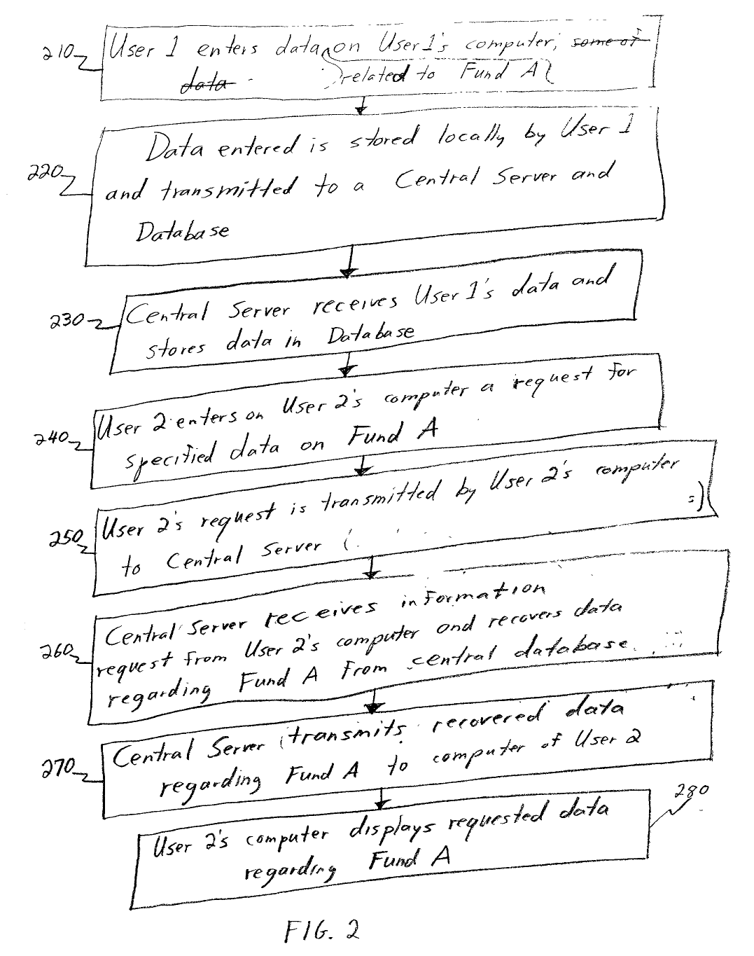

FIG. 2 illustrates steps comprised in a preferred embodiment. At step 210, a first user (User 1) enters data relating to Fund A on User 1's computer 140 (see FIG. 1). User 1 selects which fields of data are to be stored in local database 144 (all fields are stored on user database 142).

A preferred embodiment of the present invention enables data entry in at least two different forms, one for hedge fund alternative investments and another for private capital alternative investments (including LBO funds, real estate funds, and venture capital funds).

The data entry forms preferably have three general components, which comprise information on the money manager, the sponsor, and the fund. The manager's information comprises an identification of funds managed. Often, for a given fund, the sponsor is the manager (in which case only manager information is collected by the system), but sometimes the sponsor and manager are separate entities—for example, when a financial intermediary sponsors the fund.

The following outline describes data entry fields of a preferred data entry form:

| I. | Sponsor (left blank if manager is also sponsor) | |
|---|---|---|
| | A. | Address |
| | B. | Contact information |
| II. | Manager | |
| | A. | Address |
| | B. | Contact information |
| | C. | Regulatory status (e.g., whether licensed, whether registered |
| | | with Investment Management Regulatory Organisation |
| | | (IMRO) in London, etc.) |
| | D. | Personnel |

| | |
|---|---|
| 1. | Fund responsibility |
| 2. | Bio |

| | |
|---|---|
| a. | Work |
| b. | Education |

| | |
|---|---|
| 3. | Recent departures |

| | E. | Notes on Manager |
|---|---|---|
| III. | Fund—general information | |
| | A. | Advisory Board and Bios |
| | B. | Bank wiring instructions |
| | C. | Status (open, closed, listing) |
| | D. | Structure |

| | |
|---|---|
| 1. | Fees |
| 2. | Terms |

| | E. | Performance |
|---|---|---|
| | F. | Style |
| | G. | Portfolio rules |
| IV. | Time-variable parameters | |
| | A. | Asset allocation |

| | |
|---|---|
| 1. | Hedge Funds |

| | |
|---|---|
| a. | Classification |
| b. | Sector |
| c. | Region |

| | |
|---|---|
| (1) | National |

| | |
|---|---|
| 2. | Private Capital |

| | |
|---|---|
| a. | Stage |
| b. | Industry |
| c. | Region |

| | |
|---|---|
| (1) | National |
| (2) | State (or region of U.S.) |

| | |
|---|---|
| B. | Risk exposure |

| | |
|---|---|
| 1. | Factor |
| 2. | Value-at-risk (VAR) |
| 3. | Stress |

| | |
|---|---|
| C. | Leverage |
| D. | Liquidity (in days volume of shares)—preferably calculated |
| | by dividing the number of shares held by the average daily |
| | number of shares traded over a recent period |
| E. | Portfolio Pricing Sources—by percent of assets priced |
| | according to: |

| | |
|---|---|
| 1. | Standard sources (Bloomberg, Reuters, etc.) |
| 2. | Broker quotations |
| 3. | Manager model(s) |
| 4. | Manager (self-pricing) |

| V. | Fund Size | |
|---|---|---|
| VI. | Asset Metrics (for Private Capital) | |
| VII. | Fund Notes | |
| VIII. | Performance | |
| | A. | Hedge Funds |
| | B. | Private Capital |

| | |
|---|---|
| 1. | Commitment |
| 2. | Drawn down |
| 3. | Expenses |
| 4. | Distribution |

| | |
|---|---|
| a. | Dates |
| b. | Amount |

| | |
|---|---|
| (1) | Cash |
| (2) | Kind |

| | |
|---|---|
| 5. | Fair Market Value (FMV) |

| IX. | Web of Trust | |
|---|---|---|
| | A. | List of users permitted to view user's information |
| | B. | List of users whose information user is permitted to view |
| | | directly |

Information transmitted to the central server is preferably via a manual or automatic link. In a manual link, a user types information into a questionnaire (outlined above), then stores the information locally and transmits the information to a central server.

An automatic link is a link between a user database 142 and a local database 144 of a preferred system. The fields of user database 142 (which typically does not use the same database format as that of local database 144 and central database 120) are mapped to the fields of the central and local databases. This “translated” image of the user's database (that is in the format used by the central database) is preferably stored in local database 144, then mirrored to the central database 120. Thus users who have their own customized internal databases can automatically link their databases to the preferred system, removing any need to input the data twice—once to the user's own database, and once either to the local database that stores data in the preferred format used by the central database or directly to the central database 120. In an alternate embodiment, an automatic link is not used, but data entered in either the system format or the user's own format is simultaneously translated and saved in the other format on the appropriate database.

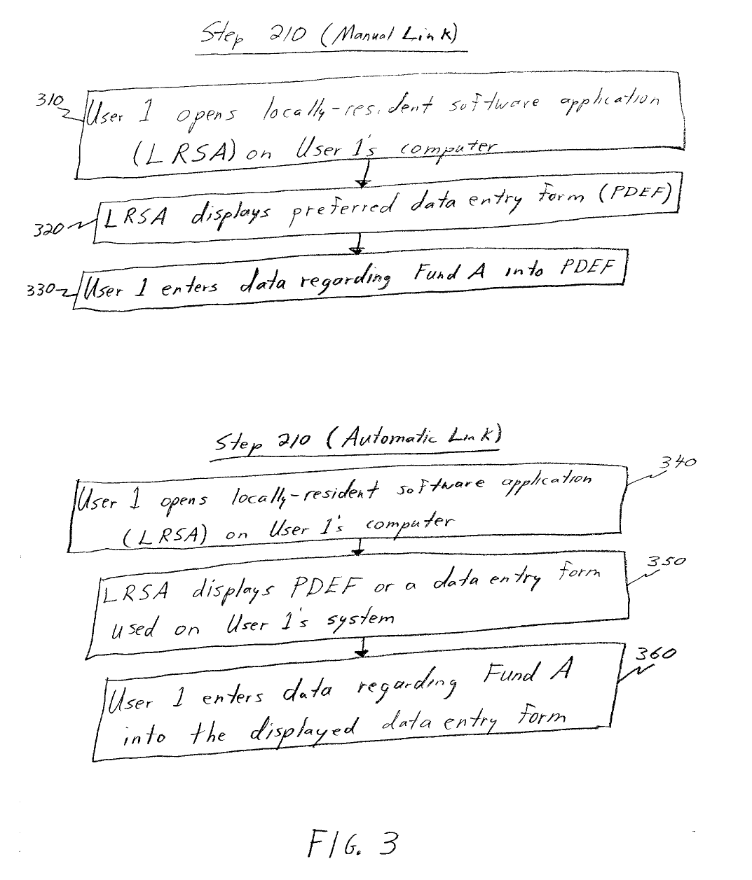

Step 210 is depicted in greater detail in FIG. 3. When a manual link is used, step 210 comprises steps 310-330; when Automatic Link is used, step 210 comprises steps 340-360.

If a manual link is used, at step 310 User 1 opens a locally-resident software application on user 1's computer 140. At step 320, the locally-resident software application displays a preferred data entry form (provided by the system operator; discussed above). At step 330, User 1 enters data regarding Fund A into the preferred data entry form.

If an automatic link is used, at step 340, as in step 310, User 1 opens a locally resident software application on User 1's computer 140. But at step 350, instead of displaying a preferred data entry form, the locally resident software application displays a form that User 1 has selected for use on User 1's own system. Typically the selected form is compatible with user database 142. At step 360, User 1 enters data regarding Fund A into the selected data entry form. As discussed above, in an alternate embodiment, User 1 enters data in the system format (used on the local and central databases), and when User 1 saves the data, it is translated to the user's format and saved on user database 142.

Returning to FIG. 2, at step 220 all data entered is stored on user database 142 and selected data (as described above) is stored on local database 144 and transmitted to central server 110 via User 1's computer 140.

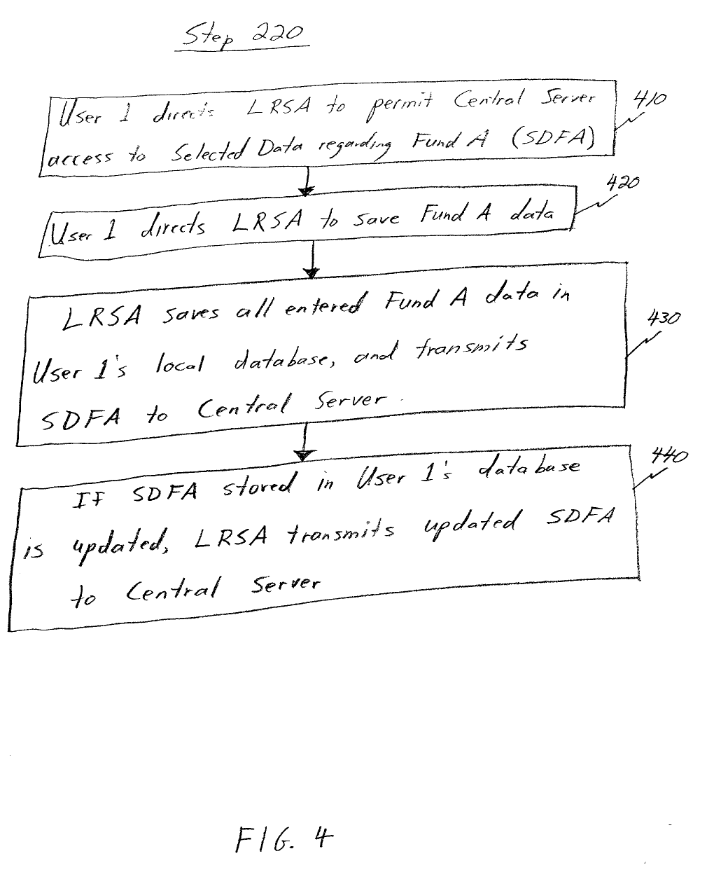

FIG. 4 depicts step 220 in greater detail. At step 410, User 1 directs the locally resident software application to permit central server 110 access to selected data regarding Fund A. In a preferred embodiment, certain fields of data must be provided and made available to the central server 110. Other fields of data can be stored on local database 144 but designated as available only to certain trusted users of the system (i.e., members of a “web-of-trust”). These two categories comprise “selected data.” Finally, even other fields can be designated as only available to the user's local system. Data in these fields is preferably not stored on local database 144, but stored only on user database 142. In an alternate embodiment, the data is stored both on local database 144 and on central database 120. Thus, the term “selected data” refers herein to data that is to be made available to other users of the preferred system on an anonymous basis, or to data that is shared with a web-of-trust. Typically, the only data that is not selected data will be user notes and capital balances, which are either stored only on the user's system or transmitted to the central server but designated as unavailable to other users.

At step 420, User 1 directs the locally resident software application to save Fund A data. At step 430, the locally resident software application saves all entered Fund A data. If field-mapping software exists between local database 144 and user database 142, then all entered Fund A data is saved to user database 144, and the selected Fund A data (preferably, all entered Fund A data except for the user's notes and capital balance) is saved to local database 144, and the data saved to local database 144 is transmitted to central server 110.

If there is no mapping between a user's local database 144 and user database 142, or if there is no user database (see user 3 configuration, FIG. 1), then at step 430 all entered data on Fund A is saved to local database 144 and transmitted to central server 110. Only selected data regarding Fund A is made available to other users of the system. In an alternate embodiment, all entered data regarding Fund A is saved to local database 144, but only selected data is transmitted to central server 110.

If an automatic link is used, any updates to the system-accessible fields on user database 142 are automatically reflected in local database 144 and transmitted to central server 110 via User 1's computer 140. At step 440, whether a manual or automatic link is used, any updates made directly to local database 144 are transmitted to central server 110 via User 1's computer 140.

Returning to FIG. 2, at step 230 central server 110 stores the received data regarding Fund A on central database 120.

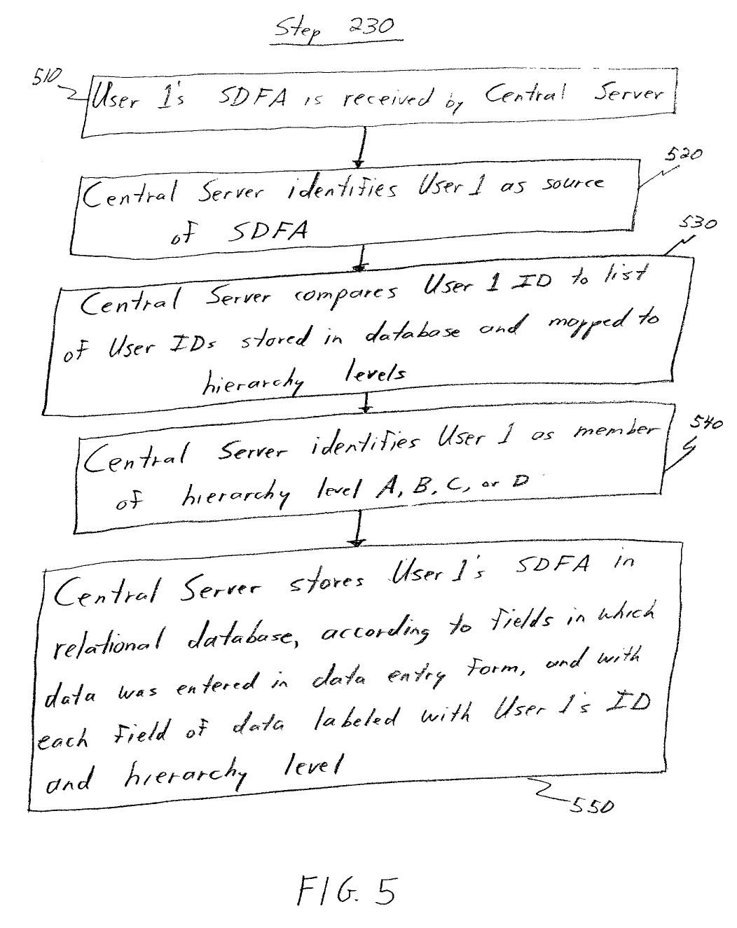

FIG. 5 depicts step 230 in greater detail. At step 510, selected data regarding Fund A is received by central server 110. At step 520, central server 110 identifies User 1 (by User 1's Edit ID—discussed below) as the source of the received Fund A information. A preferred embodiment uses a two-ID system: User IDs and Edit IDs. A User ID is a read-only ID that enables a user to view information provided by other users, but not to add or edit information displayed to other users through the system. An Edit ID enables a user to enter and change fund information on the system. Thus, in steps 210 through 230, User 1 is using an Edit ID, and in steps 240 through 280, User 2 is preferably using a User ID (although an Edit ID could also be used).

This two-ID method enables a fund manager, for example, to control which of its personnel provide fund information to the system. Preferably, a user with an Edit ID is able to have an Edit ID assigned to other personnel (e.g., data entry personnel). After data is entered and transmitted to central server 110, central server 110 preferably sends a confirmatory e-mail to the e-mail address of the user whose Edit ID was used, in order to ensure that the data was entered by authorized personnel.

At step 530, central server 110 compares User 1's ID to a list of user IDs (preferably stored in central database 120) mapped to hierarchy levels. At step 540 central server 110 identifies User 1 as a member of hierarchy level A, B, C, or D. If User 1 is a member of Level B (investors), User 1 is also preferably identified as a member of a sub-level of Level B, according to a rating system.

The central database 120 is preferably a relational database that stores data provided by users and establishes a hierarchy for received data. Hierarchy level (A-D) (discussed below) is a function of what type of entity input the information. Moreover, if the entity is an investor (Level B), that investor's information is assigned a hierarchy sub-level, depending on factors (such as historical reliability or demand) selected by a system operator.

The system preferably organizes collected data by four hierarchical levels of accuracy or trustworthiness. The highest level (Level A) comprises data submitted by an investment manager, administrator, or sponsor of the fund. The next level (Level B) comprises data submitted by an investor of the fund. Level B preferably has different levels of hierarchy based on a rating system. For example, data from investors who have a history of submitting information that has proven to be reliable is ranked higher than data from investors who have a history of submitting less reliable information.

The third level (Level C) comprises data entered by operators of the system itself; i.e., an employee of the system operator enters data collected by the system through means other than directly from users—typically, from outside sources or from analysis performed on user-submitted and/or outside data.

The lowest level (Level D) of data comes in from a third party—typically, another database or a purchased data source.

At step 550, central server 110 stores the Fund A data received from User 1 in central database 120. Central database 120 is preferably a relational database, as is known in the art, with fields that correspond to fields of a preferred data entry form. Preferably, each field of data is labeled with User 1's ID and hierarchy level (and sub-level, if applicable), to enable identification by central server 110 of the source and trustworthiness of the data when it is recovered for display to users of the system.

To ensure that the integrity of the data is relatively high, a preferred hierarchical selection process has the highest order of data quality override the lower orders. For example, when an investment manager inputs data for the fund it manages, this would be the highest level of data (Level A). In the case of Level B—an investor inputting data on an investment fund or money manager, there is preferably a second order of hierarchical evaluation. There are trusted investors whose data is determined to be prompt and more accurate than other investor data sources. Thus, there is a rating system that rates the quality of information that other investors have input to the system.

A preferred method of rating is based upon demand. Investors whose data has been used (or requested) extensively by other users are rated higher than other investors. Such ratings are preferably dynamic—each user's performance, usage, or demand is periodically re-evaluated. A data provider can be rated on accuracy, promptness, completeness of the questionnaire, and activity (e.g., how frequently they participate and contribute data).

Moreover, in keeping with the preference for the most reliable information available regarding a particular fund, users are preferably required to designate data entered as being either estimates or confirmed numbers.

Returning to FIG. 2, at step 240 a second user, User 2, enters on user 2's computer 150 (see FIG. 1) a request for specified data regarding Fund A.

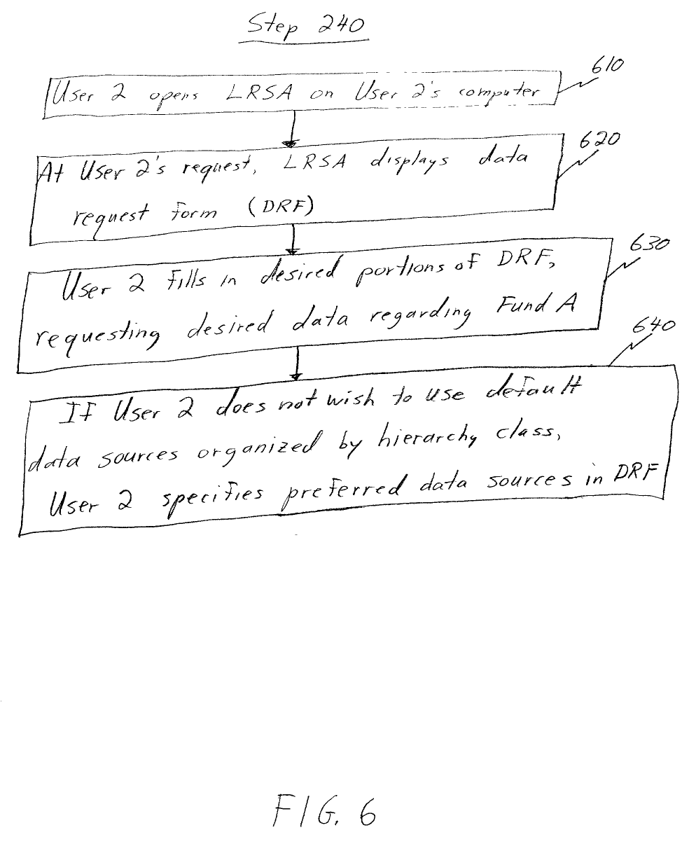

FIG. 6 illustrates step 240 in greater detail. At step 610 User 2 opens a locally-resident software application on User 2's computer 150. At step 620, User 2 requests the locally resident software application to display a data request form suitable for requesting data regarding Fund A, and the requested form is displayed.

At step 630, User 2 fills in appropriate portions of the displayed data request form to request desired data regarding Fund A. Preferably, such data comprises manager identification data, fund identification data, and if default sources are not desired, source override information (discussed below).

Unless instructed otherwise, central server 110 will transmit data from the most trustworthy source available, as determined by hierarchy level. In other words, if data regarding Fund A is available from the manager of Fund A, central server 110 will transmit that data to a user requesting it. But in a preferred embodiment transmission of data from such sources is merely a default protocol that can be overridden by a user. At step 640, if User 2 does not wish to receive the desired data from system default data sources, User 2 specifies in the data request form what data sources are preferred (i.e., specifies source override information). Source override information comprises data identifying whether the preferred source is the user's own database or another user's database (a member of the user's web-of-trust). If a user is a web-of-trust member, the user preferably has a web-of-trust ID that enables the user to directly access data provided by other members of the web-of-trust.

Returning to FIG. 2, at step 250 the information entered by User 2 into the data request form is transmitted to central server 110 by the locally resident software application. At step 260 central server 110 receives the information request from User 2's computer 150 and recovers data regarding Fund A from central database 120.

At step 270 central server 110 transmits recovered data regarding Fund A to User 2's computer 150. The data transmitted by central server 110 to User 2's computer 150 is preferably that requested by User 2, without data identifying the source(s) of the requested data (other than the hierarchy level of each data source), with one exception. The exception occurs when User 2 has requested data regarding Fund A from a specified source and that source has granted User 2 permission to access its information on central database 120. Such data is then transmitted to User 2's computer 150 along with data identifying the source of the information.

At step 280, the locally resident software application on User 2's computer displays Fund A data requested by User 2 and received from central server 110. If the above exception applies, the data requested from the specified source is displayed along with information identifying the source of the data.

In order to join a preferred system, users may remain anonymous but must answer an appropriate questionnaire and state in which level (A-D) they belong.

Preferably, for an information provider in Level D, the system uses a handshake protocol between the provider's database and a system database, and licenses the protocol to other users of the system, thus creating a subsystem. In order to qualify to become a member of this subsystem, potential members preferably complete and sign a confidentiality questionnaire, and an investor subscription questionnaire, that qualify the investor as a significant investor (for example, a Section 3(c)(1) investor or a Section 3(c)(7) investor—see Investment Company Act of 1940).

In one embodiment, the system is not only a data-sharing system but also a transaction-based system. The system is preferably registered as a broker dealer, to enable transactions to take place via the system. Users of the system, to maintain a membership at a reduced cost, are required to transact a certain number of trades or purchases of a hedge fund, LBO fund, or venture fund.

Preferably, the system is comprised primarily of sophisticated investors (e.g., Section 3(c)(1) or 3(c)(7) investors), is password protected, and investors cannot invest in a fund for a period of 30 days (in compliance with two SEC No-Action Letters to Lamp Technologies Inc. (available on Westlaw at 1997 WL 282988 and 1998 WL 278984) relating to private fund data distribution over the Internet). A request for data by a member of the system can either be an individual request or a packaged request (i.e., requesting packages of information (e.g., all funds managed by Manager X) over the system).

Software implementing a preferred embodiment comprises a software application with four primary components: (1) Trusted Data Source; (2) Search & Analysis; (3) Portfolio Reporting; and (4) Polling.

(1) The Trusted Data Source component of the preferred software comprises a local interface component that enables users to determine which data source they will use for information purposes: (a) the user's own local database; (b) a specific system user (via the central server and central database); (c) the central database; or (d) default trusted source.

(a) For data regarding a particular manager, sponsor, administrator, or fund, users can choose to use data from their own local database. This especially desirable when the fund in question is actually managed by the user.

(b) Users can request data regarding a particular fund (or manager or sponsor) from a specified database that is mirrored on the central database. This is especially desirable when the specified database is maintained by the fund manager. However, in a preferred embodiment, a user requesting access to a specified database is not granted such access until the database provider has indicated to the system operator that the requesting user is to be permitted such access. This permission is typically obtained by the requesting user directly contacting the database provider and requesting its permission. The database provider, being another user of the preferred system, notifies the system that the requesting user has permission to receive access to data in the specified database that is mirrored on the central database, and preferably indicates a time period during which such access is permitted.

(c) is self-explanatory.

(d) A default trusted source is one from which a user will receive data regarding a specified fund or manager when a source specified by the user (see (b) above) is unavailable. For example, if the user has selected another user's database, the user can specify a default source to be used in case that database is unavailable (perhaps because the user no longer has permission to access that database, or the specified database is not being mirrored by the central database).

(2) The Search and Analytics component of the preferred software has both local components (to enable a user to use the local database) and central server and central database components. Preferred searches comprise a full boolean logic search of all fields. Users can save searches and build groups from those searches. Users can also save those groups and do historical analysis on the groups. Analysis capabilities preferably comprise descriptive statistical analyses that analyze funds individually, as well as comparative analyses (funds versus indices, funds versus each other, and funds versus groups).

(3) A Portfolio Reporting component enables investors to store a portfolio of hedge funds or other alternative investments and create reporting presentations. Input portfolio information about money managers is basically an extension of the input described earlier, which could be either by a manual or automatic link. But input portfolio information is preferably organized into different categories: (a) limited partnership units (or number of shares); (b) net asset value; (c) distributions; (d) gross return; (e) net return; (f) dollar amount the user has invested in the fund; (g) dollar amount the fund is worth; and (h) value of distributions.

Although a rate of return calculation is preferably independent of whether an investor or money manager has input fund information, calculation does depend upon what type of input is used. In a preferred embodiment, input information is anonymous, so that system users do not see the dollar amounts of other user's portfolios. In order to maintain anonymity, certain data points are stripped out of the input to the reporting module. Performance-updated databases typically have preliminary estimates. For example, a hedge fund, early in the month, reports an estimated number and, at a later date, a more confirmed number. A preferred embodiment considers the later date a higher priority data point.

(4) A preferred Polling component enables users to express an interest, a request for proposals, or search for money managers, and allows other users to respond to those requests. A preferred system polls investors to see: (1) which presentations they thought were interesting; (2) what sector or what type of investments they are looking for (e.g., fee reductions or better terms); (3) what their confirmed demand is (what they would like to buy into); (4) what they would like to improve about the fund; (5) their general sentiments about the markets; (6) which investment sectors they think will be performing well over the next 12-18 months; and (7) what funds they would like to see added to the system. Polling is preferably anonymous but the system will know the user by ID (User ID or Edit ID).

A preferred system is a licensed broker dealer, so that it can syndicate investors' buying power and receive compensation from money managers for its syndication efforts. Investor buying power and interest can also be used to negotiate fund terms for participating investors. For example, a preferred system can poll users regarding what sort of terms they would prefer to receive from Fund B, and how much they would be willing to invest in Fund B if those terms were available. The preferred system can determine which terms are likely to please the largest group of investors (or the group of investors willing to invest the largest amount) and present those terms to the manager of Fund A, along with the aggregate demand numbers gathered from interested investors. Alternatively, the system can request that a fund be created to serve participant investors' term requests.

The system also preferably makes available to users newsletters, presentations, and other archival information, typically received from money managers. Users making such requests can indicate which presentations they have seen, either online or in the system. A user can also make available, either to all other users of the system or only to members of the user's web-of-trust, information such as offering memoranda, subscription documents, etc.

A preferred system requires users to contribute data on a minimum number of funds on a historic and consistent basis, as well as contribute data on dead or defunct funds. The reason investor information on defunct or dead funds is requested is to ensure that any indices that are created, or any information that is aggregated does not have survivorship bias (i.e., that an index of hedge funds, for example, is not skewed by failing to count companies in the fund that did not survive). In addition, users are preferably required to report their performance in preliminary quick estimate early reports and provide later confirmation of the numbers after the preliminary reports. Users are preferably required to exclusively participate in this system for a minimum of 3 years from the original date of sign-up.

Preferably, central server 110 has one or more of the following features.

1. Main tables for records and tables for original sources. Main table generates primary keys.

2. Source tables keep main table primary keys for each record, for easy matching.

3. Data from all sources is kept all the time (i.e., not thrown out after aggregation).

4. Data from all sources is kept historically (i.e., every time information changes, a copy of it is made to a history table).

5. Each table has a last-updated column indicating what time the information was last updated. In fact, each table can have several last-updated columns, one for each subsection of information. Having many such columns helps determine how up-to-date the information is.

6. Source Tables keep the nature of a relationship between a client and a fund. This helps identify the quality of information. For example, data received from an investor who invests in a particular fund would rank higher than data received from a non-investor.

7. Client keeps primary keys from the Main Database and sends them to central server 110. This makes synchronization easier to implement and less error-prone.

Various database schema will work with and are within the scope of the invention. One exemplary database schema for fund-related information is as follows:

[Main Fund List]

| | | |
|---|---|---|
| FundID | int | unique key, auto generated (primary key) |
| FundName | string | name of the Fund |
| Source | string | original source of the record |
| AggrRule | string | aggregation rule specific to this record |
| . . . | | |

[Source Fund Information]

| | | |
|---|---|---|
| ID | int | unique key, auto generated (primary key) |
| FundID | int | unique key from [Main Fund List]. (foreign key) |
| Source | string | indicates what commerc.db this record came from. |
| SourceID | int | primary key for this record in the source database |
| FundName | string | name of the Fund in the source database |
| LastUpdated | date | date/time this record was last updated |
| Relationship | string | indicates relationship b/w Client and this Fund. |

Additional constraint: the combination [FundID, Source] should be unique. In other words, each fund appears only once in a particular source.

[Historical Source Fund Information]

the same structure as the [Source Fund Information], except there is no constraint for [FundID, Source] to be unique. In fact, will be several records corresponding to this combination. These records represent changes in fund information and have different last-updated dates.

A preferred information packet sent from a client to central server 110 comprises a Parameters Table that contains commands to be executed, and their parameters.

Example:

| Value | Key |
|---|---|
| “Command” | “Get All Data” |
| “Command” | “Import My Data” |
| “Command” | “Funds Identified” |
| “Aggregation Rule” | “default” |
| “Since Date” | “11/01/01” |

Also included in the packet are Client Data Tables comprising, for example, a client's fund data to be uploaded to central server 110.

A preferred information packet sent from central server 110 to a client comprises a Status Table, preferably with the same format as a Parameters Table, that contains at least one (key, value) pair: (“Status”,value), where value indicates status of transaction: “OK”, “Failed”, “Identify Fund Exception”, etc.

Also included in the packet are other tables, such as tables with fund/manager information.

A preferred synchronization process comprises the following steps:

1. Receive information packet from client.

2. Convert client's data to the format of central database 120. This step is necessary only if client and server's data formats are different.

3. Process client's data record by record, preferably according to the following steps:

a. Match records against existing data from that source:

i. First try to lookup unique information about the record (such as Fund Name) in the [Source Fund Information] among existing records from this source.

ii. If record could not be located, look in [Master Fund List].

iii. If record still could not be located, search in [Master Fund List] using a “Sounds Like” function and determine close matches.

iv. If no close matches are found, this is a record that is new to the server database.

v. If more than one close match is found, prepare “Identify Fund exception.”

b. If after the matching process, the fund has been found in the database, see whether any record has been changed since previous synchronization.

c. For records that were changed, update [Source Fund Information] and [Historical Source Fund Information].

d. For records that could not be found in [Source Fund Information] among records from this source from previous synchronization, insert this record in [Source Fund Information].

4. If one or more “Identify Fund Exceptions” has occurred:

a. Prepare response to client that lists all funds that could not be matched closely with possible candidates (along with their [Main Fund List].FundIDs).

b. Send response to client.

c. Client responds with either correct [Main Fund List].FundIDs or specifies that fund is neither of the candidates.

d. [Source Fund Information] is updated for not-identified records with correct FundID.

5. Group records together that correspond to the same fund/company.

6. For each fund, choose best information available from that group according to Default Aggregation Rules and store this information in [Main Fund List]. This will be “default” aggregated information.

7. If client requested custom aggregation, repeat step 5, but store and use aggregation rules specified by client and store results in temporary table.

8. Prepare response to client:

a. Based on client's request, take either all information or information modified after “Since Date” of client's request.

b. If client requested custom aggregation, take results from temporary table created at step 6; otherwise, take data from [Master Fund List].

c. In preparing response, include client's primary keys (SourcelD from [Source Fund Information]) to make it easier for the client to absorb data.

9. Send Response to client.

Aggregation rules determine where information should come from because there are several sources of the same or similar information. A non-exhaustive list of examples of such rules is as follows:

1. Take all information from [Main Fund List].

2. Take all information from source “ABC”.

3. Take from original source ([Main Fund List].Source column).

4. Take most recent information.

5. Take most complete information.

6. Take most trustworthy information based on the “Web of Trust” (as described above).

These rules can be combined together, applied to specific records (e.g., using an AggrRule column in [Fund Information]), or applied only to parts of the information (for example, “apply this rule only to performance information”).

Preferred handling of new records comprises the following: New records are “born” on the client side. At each synchronization, the client sends new records to central server 110.

Central server 110 tries to match the new record with existing records from this client (in [Source Fund Information]) on the database and doesn't find it.

Central server 110 then inserts the new record into [Source Fund Information] but leaves a FundID column of that record blank and tries to determine the ID by searching [Main Fund List] and utilizing a “sounds like” function. If a single match is found, central server 110 updates the FundID column in [Source Fund Information] and proceeds with the synchronization process. If no matches are found, not even close ones, central server 110 inserts a new record into [Master Fund List] and updates [Source Fund Information].FundID with a newly generated FundID from [Master Fund List]. Central server 110 then proceeds with the synchronization process. If several possible matches are found, an “Identify Fund Exception” is created and a message is sent to the client asking the client to determine which of the close matches is the right fund.

The client then either identifies a fund with one of the close matches or rejects all candidates. In the first case, central server 110 updates [Source Fund Information].FundID with the identified ID. In the second case, central server 110 generates a new record in [Master Fund List] and updates [Source Fund Information].FundID with a newly generated FundID.

After aggregation, central server 110's response to the client contain this new fund information with the correct FundID from central database 120 and the client's original FundID. This allows the client to match the response from central server 110 with the client's local database and to update the local database with the central server 110 and central database 120's FundID.

As will be apparent to those skilled in the art, the above procedures can be varied without departing from the scope or spirit of the described invention. For example, identification of the funds that could not be matched confidently does not have to be done before central server 110 generates output to the client. The client might instruct the system to ignore funds that could not be closely matched and generate output without them. In this case, the final central server response will contain not only fund/manager information, but also include an “Identify Funds” request. The client then will identify funds and respond to central server 110 promptly or during the next synchronization.

Thus two procedures within the scope of the invention (although those skilled in the art will recognize others) are as follows:

Alternative A:

Client→Server: here's my list of funds/managers, get all fund data.

Server→Client: Identify the following funds: . . .

Client→Server: Correct IDs are . . .

Server→Client: requested fund data.

Alternative B:

Client→Server: here's my list of funds/managers, get all fund data, ignore new funds.

Server→Client: requested fund data; identify the following funds: . . .

During next synchronization:

Client→Server here's my list of funds/managers; get all fund data, ignore new funds; correct IDs for new finds from previous synchronization are . . .

Server→Client: requested fund data.

A preferred synchronization process includes the exchange of several information/data packets. In each case, data is sent either from central server 110 to a client or from a client to central server 110. One convenient way to exchange this information is through the HTTP Internet protocol. This protocol enables establishment of a connection from client to server, transfer of data from client to server, and transfer data from server to client. There are at least three alternative ways of exchanging data through this protocol:

A. All data is exchanged using a single client-originated connection:

1. Client connects to central server 110 and sends an information packet.

2. Central server 110 sends an information packet with a response to the client.

3. Client disconnects from central server 110.

B. Client polls server:

1. Client connects to central server 110 and sends an information packet.

2. Central server 110 acknowledges that it received packet.

3. Client disconnects from central server 110.

At a later time:

4. Client connects to central server 110 (no fund information is sent).

5. Central server 110 sends information packet with response to client.

6. Client disconnects from central server 110.

C. Using both client- and server-originated connections:

1. Client connects to central server and sends an information packet.

2. Central server 110 acknowledges that it received the packet.

3. Client disconnects from central server 110.

At a later time:

4. Central server 110 connects to client and sends information packet with response.

5. Client acknowledges that it received information.

6. Central server 110 disconnects from client.

The choice of the protocol should be based on the network configuration, processing time, and schedule of processes, as is known to those skilled in the art.

Information packet implementation can be accomplished in several ways, such as: (1) Plain Text; (2) Microsoft Access Database; or (3) XML-based database. In addition, to make data transmission faster, information packet can be compressed.

To address security concerns due to sensitivity and large quantities of information exchanged, a preferred data exchange protocol implements public/private key encryption. An exemplary protocol is described below.

1. During initial setup, clients participating in the system exchange their certificates (their public keys signed by a signing authority, such as VeriSign Inc).

2. When a client sends an information packet to central server 110, the packet is encrypted with both central server 110's public key and the client's private key.

3. When central server 110 receives the information packet central server 110 decrypts the information packet using central server 110's own private key and the client's public key. This ensures that only central server 110 can decrypt such an information packet and that it could come only from the client.

4. When central server 110 sends an information packet with a response to the client, the above process repeats symmetrically.

Partial/full synchronization: When data is exchanged between client and server, the system described above preferably allows for either partial data or full data to be exchanged. This is done through the use of a “Since Date” parameter and the client's decision on what records to send to central server 110.

It is recommended that in order to improve performance, partial synchronization should be used. But it is also recommended that full synchronization occasionally be performed to avoid data discrepancies caused by errors in programs.

While the method and system of the present invention has been described in connection with a preferred embodiment, the invention is not intended to be limited to the specific form or forms set forth herein, but on the contrary is intended to cover such alternatives, modifications, and equivalents as may be reasonably included within the spirit and scope of the invention as defined by the appended claims.

What is claimed is:

1. A method for sharing information over a computer network, comprising:
(a) receiving data regarding a particular investment over a computer network from a first user computer;
(b) storing the data from the first user in a relational database and identifying the data as coming from the first user, wherein the first user is identified as a member of a hierarchy of sources organized by level of trustworthiness;
(c) receiving a request over the computer network from a second user for data from the relational database regarding the particular investment; and
(d) in response to the request from the second user, transmitting the data from the relational database to a second user computer, wherein, absent a request from the second user for data from a specific source or level of trustworthiness, the data transmitted comprise data from users of the highest level of trustworthiness available.

2. A method as in claim 1, wherein the data received from the first user comprises alternative investment data.

3. A method as in claim 1, wherein sources of the highest level of trustworthiness comprise investment managers, fund administrators, or fund sponsors.

4. A method as in claim 1, wherein sources of at least one level of trustworthiness comprise investors, and wherein the investor level is subdivided into two or more sublevels that are determined at least partly by reliability of previously submitted information.

5. A method as in claim 1, wherein sources of at least one level of trustworthiness comprise investors, and wherein the at least one investor level is subdivided into two or more sublevels, and wherein an investor's sublevel is determined at least partly by amount of demand for the investor's information by other investors.

6. A method as in claim 2, wherein the alternative investment data from the first user comprises fund data.

7. A method as in claim 6, further comprising a method for identifying unrecognized funds, comprising:
(a) attempting to match an unrecognized fund with existing fund records;
(b) if no match is found, searching existing fund records using a sounds-like function;
(c) if no match is found by step (b), identifying the unrecognized fund as a new fund; and
(d) if multiple matches are found by step (b), transmitting a list of the matches to the first user, with a request to identify the correct fund.

8. A system for sharing information over a computer network, comprising:
(a) means for receiving data regarding a particular investment over a computer network from a first user computer;
(b) means for storing the data from the first user in a relational database and identifying the data as coming from the first user, wherein the first user is identified as a member of a hierarchy of sources organized by level of trustworthiness;
(c) means for receiving a request over the computer network from a second user for data from the relational database regarding the particular investment; and
(d) means for, in response to the request from the second user, transmitting the data from the relational database to a second user computer, wherein, absent a request from the second user for data from a specific source or level of trustworthiness, the data transmitted comprise data from users of the highest level of trustworthiness available.

9. A system for sharing information over a computer network, comprising:
(a) a central database; and
(b) a central server linked to the central database and linked to a computer network;
wherein the central database is a relational database configured to identify at least some data with the source of the data; and
wherein each data source is designated as a member of a hierarchy of sources organized by level of trustworthiness.

10. A system as in claim 9, wherein data in the central database comprises alternative investment data.

11. A system as in claim 9, wherein sources of the highest level of trustworthiness comprise investment managers, fund administrators, or fund sponsors.

12. A system as in claim 9, wherein sources of at least one level of trustworthiness comprise investors, and wherein the at least one investor level is subdivided into two or more sublevels that are determined at least partly by reliability of previously submitted information.

13. A system as in claim 9, wherein sources of at least one level of trustworthiness comprise investors, and wherein the investor level is subdivided into two or more sublevels, and wherein an investor's sublevel is determined at least partly by amount of demand for the investor's information by other investors.

14. A method of obtaining and providing information regarding alternative investments, comprising the following steps:
(a) providing over a computer network in a secure manner to a central server data regarding one or more alternative investments, wherein the alternative investment data comprises financial data and information indicating at least one source of the financial data;
(b) requesting information regarding one or more alternative investments; and
(c) receiving information comprising the requested information;
wherein the central server is in communication with a central database that is a relational database configured to identify at least some data with the source of the data; and
wherein each data source is designated as a member of a hierarchy of sources organized by level of trustworthiness.
